(19) United States
(12) Patent Application Publication
(10) Pub. No.: US 2002/0067260 A1
(43) Pub. Date: Jun. 6, 2002

(54) Position sensor

(75) Inventors: Masaya Tajima, Aichi (JP); Katsuya Kogiso, Aichi (JP)

Correspondence Address: Andrew J. Nilles, NILLES & NILLES, S.C., Firstar Center, Suite 2000, 777 East Wisconsin Avenue, Milwaukee, WI, 53202, US

(73) Assignee: Kabushiki Kaisha Tokai Rika Denki Seisakusho

(21) Appl. No.: 09/946,642

(22) Filed: Sep. 4, 2001

(30) Foreign Application Priority Data
Sep. 5, 2000 (JP) 2000-268958

(51) Int. Cl. G08B 13/24

(52) U.S. Cl. 340/551; 340/457.1

(57) ABSTRACT

A position sensor has a magnet producing a magnetic field and a magnetic detector for detecting the magnetic field. The detector produces a resistance value variable according to the orientation of the magnetic field. The magnet and the magnetic detector are arranged to move relative to each other within a predetermined stroke so that the detector outputs a voltage signal with a predetermined waveform having a rate of change that prohibits the signal excessive of a predetermined value to return to the predetermined value.

### BACKGROUND OF THE INVENTION

The present invention relates to a position sensor that uses magnetic detection.

FIG. 5 illustrates a noncontact type position sensor 51 that uses a magnetic resistance element (MRE) 52. The position sensor 51 is used, for example in a buckle switch of a seat belt. The position sensor 51 includes an IC package 53, which accommodates the MRE 52, and a magnet 54, which is movable relative to the IC package 53.

The MRE 52 detects the magnetic field Ho of the magnet 54 through a detection face. Specifically, the MRE 52 detects the magnetic flux of the magnetic field Ho that passes through the detection face and outputs a signal that represents the orientation of the passing flux. When the orientation of the passing flux is aligned with the centerline L of the MRE 52, the output of the MRE 52 is substantially zero. The centerline L is perpendicular to the stroke direction D of the magnet 54, which is represented by a broken line in FIG. 5. The polar axis of the magnet 54 is parallel to the stroke direction D.

When the tongue of a seat belt is engaged with the buckle, the magnet 54 is moved in the stroke direction D relative to the IC package 53 within a predetermined stroke range. The MRE 52 in the IC package 53 detects a change in the orientation of the passing magnetic flux of the magnetic field Ho. At this time, the signal generated by the MRE 52 has a sinusoidal waveform as shown in the graph of FIG. 6. When the output voltage exceeds zero due to movement of the magnet 54, or when the magnet 54 moves beyond point A in FIG. 6, the buckle switch is turned on.

However, due to manufacturing deviations in the MRE 52, the magnet 54 and the peripheral circuits and due to errors produced by assembling the IC package 53 and the magnet 54, the waveform of the output signal from the MRE 52 may be shifted as shown by the broken line in FIG. 6.

In this case, the output voltage becomes zero when the magnet 54 moves beyond point B in FIG. 6, which is close to the end of the stroke. That is, after being turned on, the buckle switch is turned off when the magnet 54 is at the limit of its movement. In other words, the buckle is turned off when the buckle switch must be turned on to detect that the tongue is engaged with the buckle.

### BRIEF SUMMARY OF THE INVENTION

Accordingly, it is an objective of the present invention to provide a magnetic position sensor that performs highly accurate detection.

In relation with the above objectives, the present invention provides a position sensor that prevents erroneous detection due to deviations of the elements and to errors produced by assembling the elements.

To achieve the foregoing and other objectives and in accordance with the purpose of the present invention, a position sensor including a magnet and a magnet detector is provided. The magnet produces a magnetic field. The magnetic detector detects the magnetic field. The detector produces a resistance value variable according to the orientation of the magnetic field. The magnet and the magnetic detector are arranged to move relative to each other within a predetermined stroke so that the detector outputs a voltage signal with a predetermined waveform having a rate of change that prohibits the signal excessive of a predetermined value to return to the predetermined value.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWING

The invention, together with objects and advantages thereof, may best be understood by reference to the following description of the presently preferred embodiments together with the accompanying drawings in which:

FIG. 1 is a diagrammatic view illustrating the operation of a position sensor according to one embodiment of the present invention;

FIG. 2 is a graph showing the waveform of a voltage signal generated by the magnetic resistance element in the position sensor of FIG. 1;

FIG. 3(a) is a plan view illustrating the magnetic resistance element in the position sensor of FIG. 1;

FIG. 3(b) is a graph showing the waveform of the output voltage of the magnetic resistance element in the position sensor of FIG. 1 relative to the orientation of a passing magnetic flux;

FIG. 4 is a diagrammatic view illustrating the operation of a position sensor according to another embodiment in which a magnetic member is attached to a magnet;

FIG. 5 is a diagrammatic view illustrating the operation of a prior art position sensor; and

FIG. 6 is a graph showing the waveform of the output characteristics of the magnetic resistance element in the prior art position sensor of FIG. 5.

### DETAILED DESCRIPTION OF THE PREFERRED EMBODIMENTS

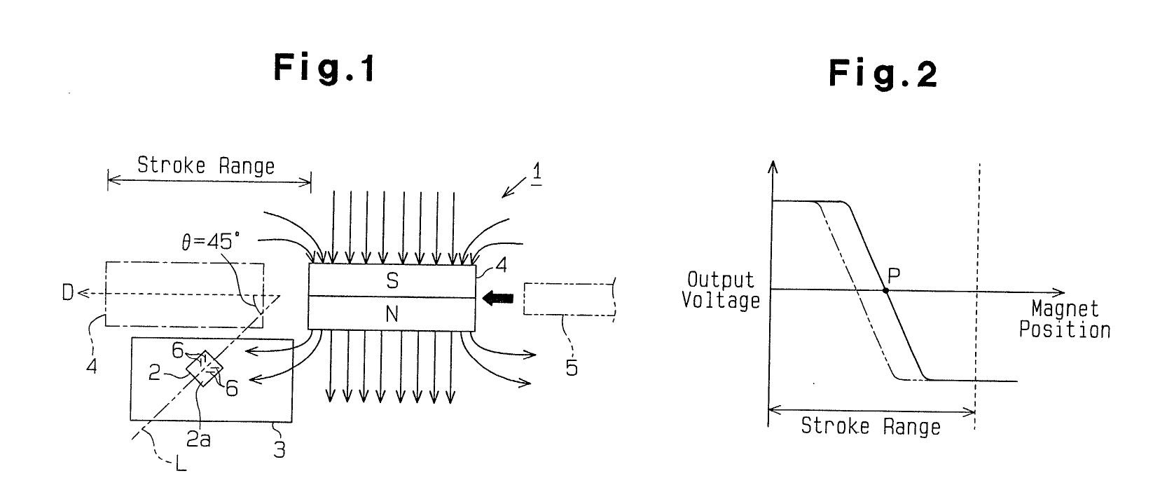

A position sensor 1 according to one embodiment of the present invention will now be described with reference to FIGS. 1 to 4.

The position sensor 1 is used, for example, in a buckle switch of a vehicle seat belt assembly. The position sensor 1 includes an IC package 3 and a magnet 4. The IC package 3 includes a magnetic resistance element (MRE) 2. The magnet 4 moves relative to the IC package 3. A movable member 5 moves as the tongue (not shown) of a seat belt is engaged with a buckle. When the tongue is engaged with the buckle, the movable member 5 pushes the magnet 4 in a stroke direction D, or in the direction of the arrow in FIG. 1.

The south pole of the magnet 4 is located in the upper portion, and the north pole is located in the lower portion of the magnet 4, as viewed in FIG. 1. The polar axis of the magnet is perpendicular to the stroke direction D. As the movable member 5 moves, the magnet 4 is moved in the stroke direction D within a stroke range.

The MRE 2 has magnetic resistors 6, the number of which is, for example, four. The resistors 6 are located on an element surface 2a of the MRE 2 and are made of Ni—Co material. The resistors 6 detect a magnetic field that lies parallel to the element surface 2a. The resistors 6 have directivity relative to a magnetic field and generate different voltage signals depending on the orientation of the passing flux of the magnetic field. The directivity of the resistors 6 varies in accordance with the arrangement of the resistors 6.

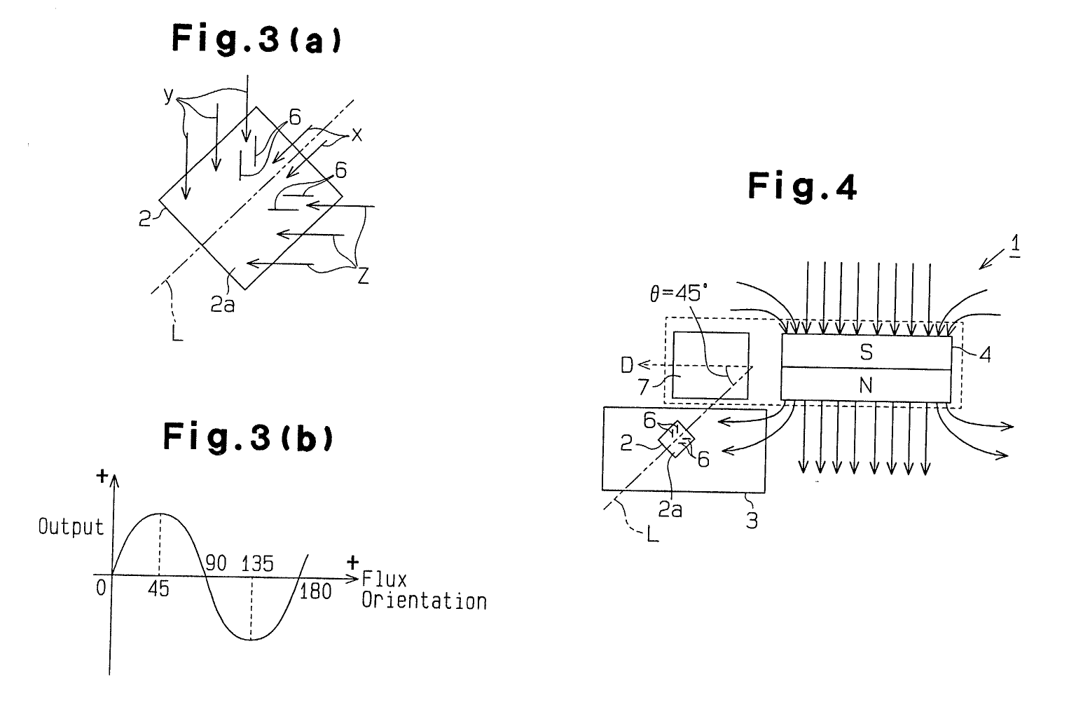

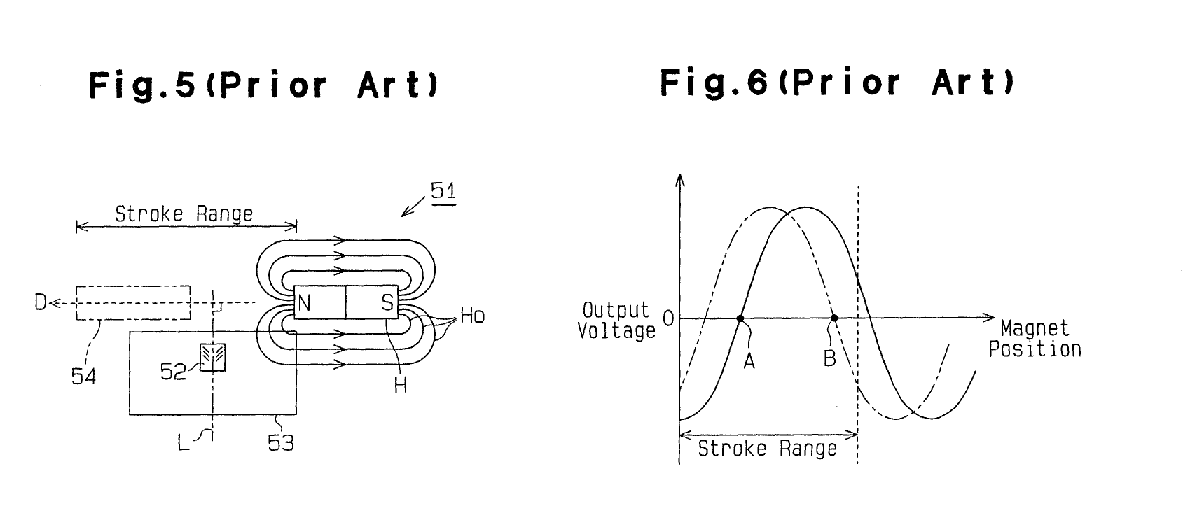

The resistors 6 are arranged such that the characteristics of the output voltage in relation to the orientation of a passing magnetic flux appears as a sinusoidal waveform, the phase of which is 180 degrees, as shown in FIG. 3(b). Thus, as shown in FIG. 3(a), when the orientation of the passing magnetic flux is represented by arrows x, which are parallel to the centerline L of the MRE 2, the output voltage is substantially zero. The MRE 2 is symmetric with respect to the centerline L.

When the orientation of the passing magnetic flux is represented by arrows y, which are inclined by −45 degrees relative to the centerline L, the output voltage of the MRE 2 is minimized. When the orientation of the passing magnetic flux is represented by arrows z, which are inclined by +45 degrees relative to the centerline L, the output voltage is maximized. As shown in FIG. 1, the centerline L of the MRE 2 is inclined substantially by 45 degrees relative to the stroke direction D.

The operation of the position sensor 1 will now be described.

FIG. 2 is a graph showing the waveform of the voltage generated by the MRE 2 as the magnet 4 is moved in the stroke direction D. When the tongue of the seat belt is engaged with the buckle, the magnet 4 is pushed by the movable member 5 and moves in the stroke direction D. At this time, the waveform of the voltage signal generated by the MRE 2 is represented by the solid line in FIG. 2. That is, at the beginning of the stroke, the voltage is maximized. As the magnet 4 is moved in the stroke direction D, the voltage is gradually decreased. At the end of the stroke, the voltage is minimized. When the voltage is decreased and becomes equal to zero (point P in FIG. 2), the position sensor 1 detects that the tongue is engaged with the buckle.

Therefore, once the voltage is equal to or lower than zero during the buckling process, the voltage remains equal to or lower than zero. Thus, even if the waveform is shifted due to the manufacturing deviations of the MRE 2 and the magnet 4 or due to errors produced by assembling the IC package 3 and the magnet 4, the sensor 1 reliably detects whether the tongue is engaged with the buckle. That is, when the tongue is engaged with the buckle, the sensor 1 does not erroneously detect that the tongue is disengaged from the buckle. When manufacturing deviations and assembly errors exist, erroneous detections by the position sensor 1 are prevented.

Another embodiment will now be described reference to FIG. 4. Like or the same reference numerals are given to those components that are like or the same as the corresponding components of the embodiment of FIGS. 1 to 3(b). In the embodiment of FIG. 4, a magnetic member 7, which is made of, for example, iron, is aligned with the magnet 4 in the stroke direction D. The magnetic member 7 moves integrally with the magnet 4. The magnetic member 7 concentrates the magnetic flux generated by the magnet 4, which improves the sensitivity of the position sensor 1.

In the illustrated embodiments, the rate of change of the voltage signal relative to the magnet position is relatively gradual compared to that of the prior art. That is, the wavelength of the output voltage is longer than that of the prior art. Unlike the prior art, the voltage signal passes the voltage value of zero only at one point in the stroke range as shown in FIG. 2. Therefore, once the voltage value passes the value zero and the sensor 1 detects the engagement between the tongue and the buckle, the voltage value does not again pass the zero point as long as the engagement is maintained. Thus, even if the waveform is shifted due to manufacturing deviations of the MRE 2 and the magnet 4 or due to errors produced by assembling the IC package 3 and the magnet 4, the sensor 1 continues detecting the engagement. That is, even if manufacturing deviations and assembly errors exist, erroneous detections by the position sensor 1 are prevented.

Also, in the illustrated embodiments, the MRE 2 is arranged such that its centerline L is inclined by substantially 45 degrees relative to the stroke direction D. At the beginning of the stroke of the magnet 4, the magnetic field the orientation of which is +45 degrees passes over the element surface 2a. When the magnet is maximally stroked, the magnetic field the angle of which is −45 degrees passes over the element surface 2a. Therefore, the difference between the output voltage at the beginning of the stroke and the output voltage at the maximum stroke is relatively great, which improves the waveform characteristics of the output voltage. Thus, even if there is external disturbance such as noise, erroneous detections are prevented.

It should be apparent to those skilled in the art that the present invention may be embodied in many other specific forms without departing from the spirit or scope of the invention. Particularly, it should be understood that the invention may be embodied in the following forms.

The orientation of the MRE 2 relative to the stroke direction D is not limited to 45 degrees. For example, the angle may vary in a range from 40 degrees to 50 degrees. Further, the orientation angle may be out of the range between 40 and 50 degrees as long as the MRE 2 is not perpendicular to the stroke direction D.

In the illustrated embodiments, the MRE 2 is inclined clockwise from vertical as viewed in the drawings. However, the MRE 2 may be inclined in the counterclockwise direction. In this case, the voltage value gradually increases as the magnet 4 moves. As in the illustrated embodiment, once the sensor 1 detects that the tongue is engaged with the buckle, the sensor 1 continues detecting the engagement even if the waveform is shifted.

The value of the voltage generated by the MRE 2 at which the sensor 1 detects that the tongue is engaged with the buckle is not limited to zero. That is, the engagement may be detected at a voltage value other than zero. Also, the sensor 1 may detect that the tongue is disengaged from the buckle when the output voltage is zero.

In the embodiment of FIG. 4, in which the magnetic member 7 is used for concentrating magnetic flux, the material of the member 7 is not limited to iron but may be another material such as nickel or cobalt. When nickel is used, the member 7 may be formed by applying nickel on a resin material.

In the illustrated embodiments, the magnet 4 is moved relative to the IC package 3, which is stationary. However, the magnet 4 may be stationary and the IC package 3 may be moved relative to the magnet 4. Alternatively, the magnet 4 may be fixed to the movable member 5 so that the magnet 4 moves integrally with the movable member 5.

The position sensor 1 may be used in devices other than the seat belt buckle switch. For example, the position sensor 1 may be used in vehicle devices other than seat belt. Alternatively, the sensor 1 may be used in a device that is not used in a vehicle.

Therefore, the present examples and embodiments are to be considered as illustrative and not restrictive and the invention is not to be limited to the details given herein, but may be modified within the scope and equivalence of the appended claims.

1. A position sensor comprising:
a magnet producing a magnetic field;
a magnetic detector for detecting the magnetic field, said detector producing a resistance value variable according to the orientation of the magnetic field; and
said magnet and the magnetic detector being arranged to move relative to each other within a predetermined stroke so that the detector outputs a voltage signal with a predetermined waveform having a rate of change that prohibits the signal excessive of a predetermined value to return to the predetermined value.

2. The position sensor as set forth in claim 1, wherein said magnet has a north pole and a south pole defining a polar axis perpendicular to the direction of the relative movement and wherein said detector has a surface including a plurality of magnetic resistors arranged such that a characteristic of the output signal is a sinusoidal waveform.

3. The position sensor as set forth in claim 2, wherein said surface of the detector has a centerline parallel to the orientation of magnetic field leading the voltate signal to be zero, wherein the centerline extends obliquely in respect with the direction of the relative movement.

4. The position sensor as set forth in claim 3, wherein the centerline is inclined by substantially 45 degrees relative to the direction of the relative movement.

5. The position sensor as set forth in claim 1, further comprising a magnetic member aligned with the magnet in the direction of the relative movement.

6. The position sensor as set forth in claim 1, wherein the magnetic member is made of iron.

7. The position sensor as set forth in claim 1, wherein said position sensor is used in a seat belt device in a vehicle.

8. A position sensor comprising:
a magnet producing a magnetic field;
a magnetic detector for detecting the magnetic field, said detector producing a resistance value variable according to the orientation of the magnetic field; and
said magnet and the magnetic detector being arranged to move relative to each other within a predetermined stroke so that the detector outputs a voltage signal with a predetermined waveform having a rate of change that prohibits the signal excessive of a predetermined value to return to the predetermined value, wherein said magnet has a north pole and a south pole defining a polar axis perpendicular to a direction of the relative movement and wherein said detector has a surface including a plurality of magnetic resistors arranged such that a characteristic of the output signal is a sinusoidal waveform.

9. The position sensor as set forth in claim 8, wherein said surface of the detector has a centerline parallel to the orientation of magnetic field leading the voltage signal to be zero, wherein the centerline extends obliquely in respect with the direction of the relative movement.

10. The position sensor as set forth in claim 9, wherein the centerline is inclined by 45 degrees relative to the direction of the relative movement.

11. The position sensor as set forth in claim 8, further comprising a magnetic member aligned with the magnet in the direction of the relative movement.

12. The position sensor as set forth in claim 8, wherein the magnetic member is made of iron.

13. The position sensor as set forth in claim 8, wherein said position sensor is used in a seat belt device in a vehicle.
